(19) United States
(12) Patent Application Publication
(10) Pub. No.: US 2025/0202597 A1
(43) Pub. Date: Jun. 19, 2025

(54) SUBMARINE OPTICAL COMMUNICATION SYSTEM

(71) Applicant: NEC Corporation, Minato-ku, Tokyo (JP)

(72) Inventor: Takaaki TAKEDA, Tokyo (JP)

(73) Assignee: NEC Corporation, Minato-ku, Tokyo (JP)

(21) Appl. No.: 18/847,872

(22) PCT Filed: Mar. 31, 2022
(86) PCT No.: PCT/JP2022/016400

§ 371 Date: Sep. 17, 2024

(51) Int. Cl. H04B 10/80; H04Q 11/00

(52) U.S. Cl. CPC H04B 10/80; H04Q 11/0005; H04Q 2011/0016; H04Q 2011/0041; H04Q 2213/13217

(57) ABSTRACT

In order to be able to check a submarine optical cable in use while improving reliability, this submarine optical communication system has a loopback circuit included in a second path, and the loopback circuit includes: a first input port that receives a first optical signal output by a first switch; a splitter that causes the first optical signal input from the first input port to split; a first output port that outputs, to a second switch, one of the first optical signals split by the splitter; and a second output port that outputs, to a first optical receiver, at least a portion of the other of the first optical signals split by the splitter.

### TECHNICAL FIELD

The present invention relates to, for example, a submarine optical communication system capable of confirming a submarine optical cable being used.

### BACKGROUND ART

In a submarine optical communication system, a terminal station installed ashore performs optical communication via a submarine optical cable laid on a sea bottom. At that time, in order to improve reliability of the submarine optical communication system, the submarine optical cable may include a redundant configuration. The redundant configuration of the submarine optical cable may include, for example, a plurality of transmission submarine cables and a plurality of reception submarine cables. PTL 1, for example, discloses a submarine optical communication system including a plurality of transmission submarine cables and a plurality of reception submarine cables.

In the submarine optical communication system, when a plurality of transmission submarine cables and a plurality of reception submarine cables are used, a terminal station switches, for example, by using an optical switch or the like installed on a submarine optical cable, a submarine optical cable to be used. At that time, the submarine optical communication system may perform communication, in order to confirm that an appropriate submarine optical cable is being used, from a communication device included in an optical switch or the like to a terminal station.

### CITATION LIST

### Patent Literature

PTL 1: Japanese Unexamined Patent Application Publication No. H07-087013

### SUMMARY OF INVENTION

### Technical Problem

However, a very high cost is required for repairing a submarine optical cable, and therefore for a submarine optical cable, improvement in reliability, such as reduction of the number of components and a movable unit, is required. Therefore, a configuration in which a communication device is provided for an optical switch and the like as described above is not preferable from a point of view of improving reliability.

In view of the above-described problem, an object of the present invention is to provide a submarine optical communication system capable of confirming a submarine optical cable being used while improving reliability.

### Solution to Problem

The present invention is a submarine optical communication system including a first terminal station, a first splitting device, a second splitting device, and a second terminal station,
the submarine optical communication system including:
the first terminal station including a first optical transmission means for outputting a first optical signal to the first splitting device, and a first optical reception means:
the first splitting device including a first switching means for outputting a first optical signal being output from the first optical transmission means toward the second splitting device via a first path or a second path:
the second splitting device including a second switching means for outputting, toward the second terminal station, the first optical signal being output from the first switching means via the first path or the second path: and
the second terminal station including a second optical reception means for receiving the first optical signal from the second switching means, wherein
the second path includes a loopback means, and
the loopback means includes
   a first input port that receives the first optical signal being output from the first switching means,
   a splitting means for splitting the first optical signal being input from the first input port,
   a first output port that outputs, to the second switching means, one of the first optical signal being split by the splitting means, and
   a second output port that outputs, to the first optical reception means, at least a part of another of the first optical signal being split by the splitting means.

### Advantageous Effects of Invention

According to the present invention, it is possible to provide a submarine optical communication system capable of confirming, while improving reliability, that an appropriate submarine optical cable is being used.

### BRIEF DESCRIPTION OF DRAWINGS

FIG. 1 is a block diagram illustrating a configuration example of a submarine optical communication system according to a first example embodiment of the present invention.

FIG. 2 is a diagram illustrating details of the submarine optical communication system according to the first example embodiment of the present invention.

FIG. 3 is a diagram illustrating details of the submarine optical communication system according to the first example embodiment of the present invention.

FIG. 4 is a diagram illustrating details of the submarine optical communication system according to the first example embodiment of the present invention.

FIG. 5 is a block diagram illustrating a configuration example of a submarine optical communication system according to a second example embodiment of the present invention.

FIG. 6 is a diagram illustrating details of the submarine optical communication system according to the second example embodiment of the present invention.

### EXAMPLE EMBODIMENT

### First Example Embodiment

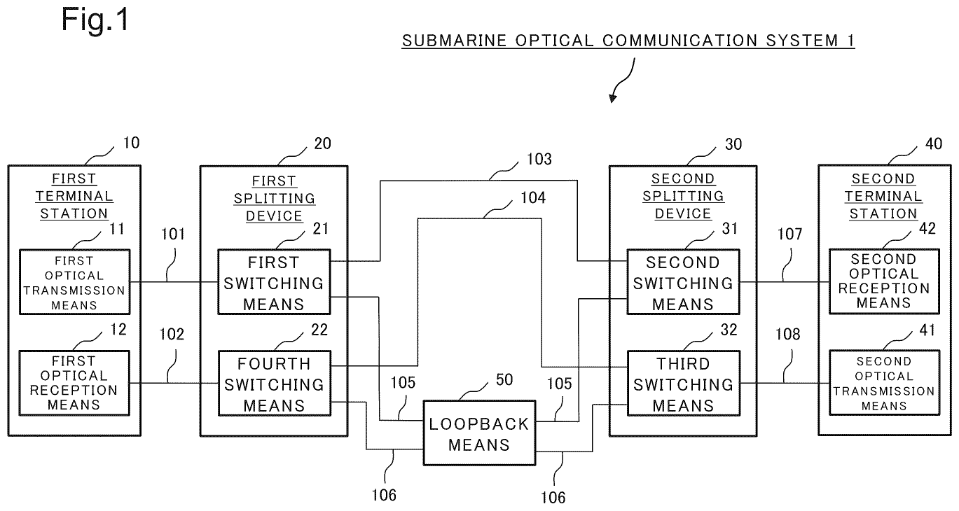

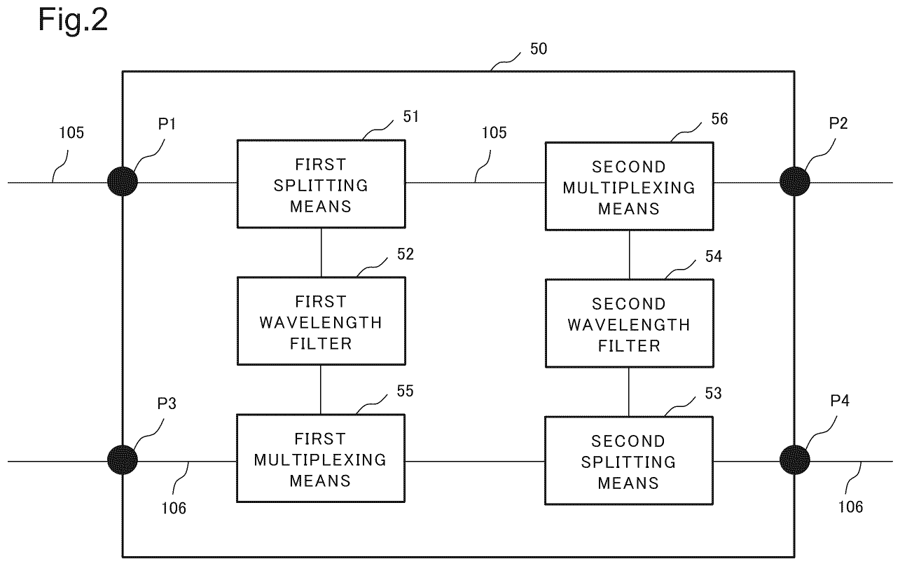

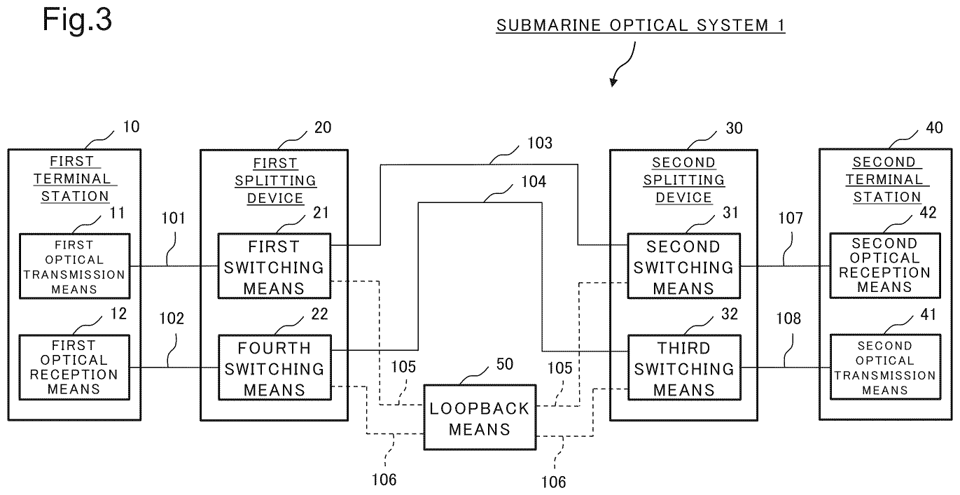

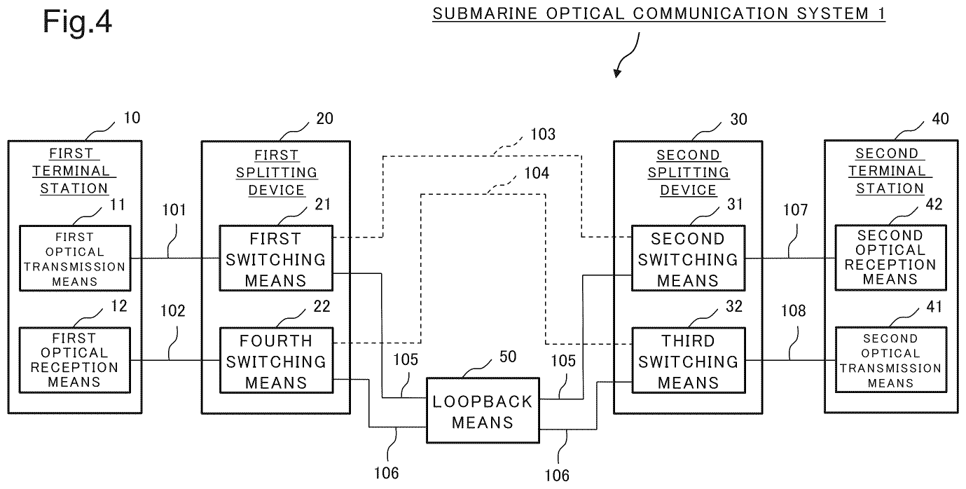

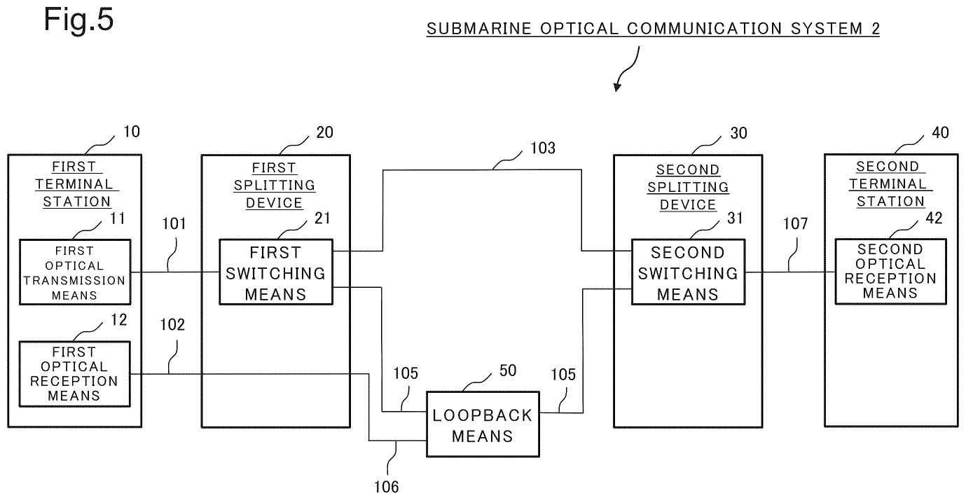

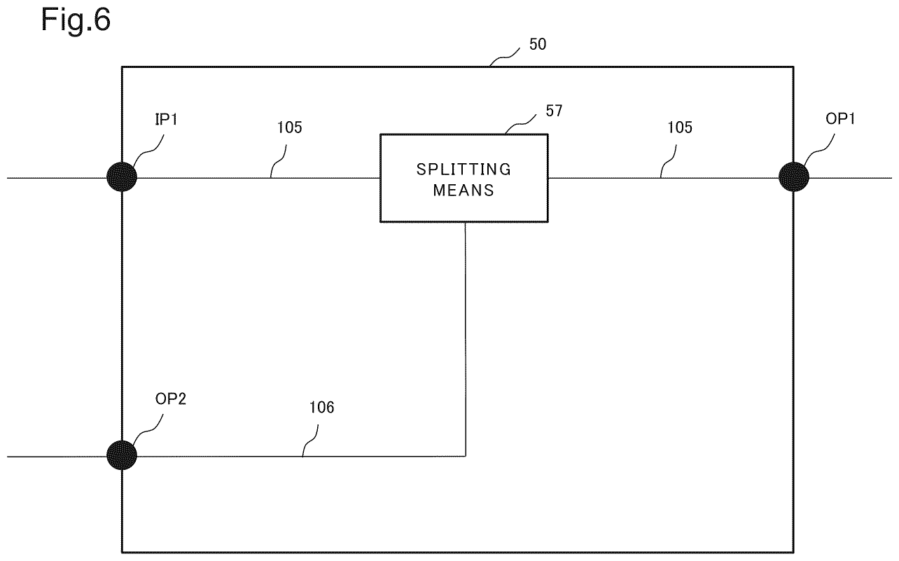

A submarine optical communication system 1 according to a first example embodiment is described based on FIG. 1, FIG. 2, FIG. 3, FIG. 4, and FIG. 5. FIG. 1 is a block diagram illustrating a configuration example of the submarine optical communication system 1. FIG. 2, FIG. 3, FIG. 4, and FIG. 5 are diagrams illustrating details of the submarine optical communication system 1. FIG. 6 is a flowchart illustrating an operation example of the submarine optical communication system 1.

As illustrated in FIG. 1, the submarine optical communication system 1 includes a first terminal station 10, a first splitting device 20, a second splitting device 30, a second terminal station 40, and a loopback means 50. As illustrated in FIG. 1, components of the submarine optical communication system 1 are relevantly connected to one another by submarine optical cables 101, 102, 103, 104, 105, 106, 107, and 108. It is assumed that the submarine optical cables 101 to 108 are cables including an optical fiber and are laid on the sea bottom. The submarine optical cables 101 to 108 may further include an optical component such as an optical amplifier and a gain equalizer.

The first terminal station 10 is a landing station provided ashore. The first terminal station 10 includes a first optical transmission means 11 and a first optical reception means 12.

The first optical transmission means 11 outputs a first optical signal to the first splitting device 20. Specifically, the first optical transmission means 11 outputs, via the submarine optical cable 101, a first optical signal to a first switching means 21 inside the first splitting device 20. The first optical signal is, for example, a wavelength division multiplexed (WDM) optical signal. The first optical signal includes, for example, a first band and a second band. The first band is allocated to an optical signal including information toward the second terminal station 40. The second band is allocated to a first monitoring optical signal. The first band and the second band are bands different from each other.

The first optical reception means 12 receives an optical signal input via the submarine optical cable 102. Specifically, the first optical reception means 12 receives an optical signal output from the second terminal station 40.

The first splitting device 20 includes a first switching means 21 and a fourth switching means 22. The first switching means 21 outputs, via the submarine optical cable 103 or the submarine optical cable 105, a first optical signal from the first optical transmission means 11 toward the second splitting device 30. The submarine optical cable 103 is relevant to a first path. The submarine optical cable 105 is relevant to a second path.

An optical signal output from the second terminal station 40 is input to the fourth switching means 22 via the submarine optical cable 104 or the submarine optical cable 105. The fourth switching means 22 outputs the input optical signal to the first optical reception means 12 via the submarine optical cable 102. The first switching means 21 and the fourth switching means 22 are, for example, an optical switch.

The second splitting device 30 includes a second switching means 31 and a third switching means 32. An optical signal output from the first terminal station 10 is input to the second switching means 31 via the submarine optical cable 103 or the submarine optical cable 105. The second switching means 31 outputs the input optical signal to the second terminal station 40 via the submarine optical cable 107.

The third switching means 32 outputs, via the submarine optical cable 104 or the submarine optical cable 106, an optical signal output from the second optical station 40 toward the first splitting device 20. The second switching means 31 and the third switching means 32 are, for example, an optical switch.

The second terminal station 40 is a landing station provided a shore. The second terminal station 40 includes a second optical transmission means 41 and a second optical reception means 42.

The second optical transmission means 41 outputs a second optical signal to the second splitting device 30. Specifically, the second optical transmission means 41 outputs, via the submarine optical cable 108, a second optical signal to the third switching means 32 inside the second splitting device 30. The second optical signal is, for example, a WDM optical signal. The second optical signal includes, for example, a third band and a fourth band. The third band is allocated to an optical signal including information toward the first terminal station 10. The fourth band is allocated to a second monitoring optical signal. The third band and the fourth band are bands different from each other.

The second optical reception means 42 receives an optical signal input via the submarine optical cable 107. Specifically, the second optical reception means 42 receives an optical signal output from the first terminal station 10.

By using FIG. 2, the loopback means 50 is described. The loopback means 50 is included in the submarine optical cable 105 and the submarine optical cable 106. As illustrated in FIG. 2, the loopback means 50 includes a first splitting means 51, a first wavelength filter 52, a second splitting means 53, a second wavelength filter 54, a first multiplexing means 55, and a second multiplexing means 56. The loopback means 50 includes optical ports P1, P2, P3, and P4 to/from which an optical signal is input/output.

A first optical signal output from the first switching means 21 is input to the optical port P1. The optical port P1 is relevant to a first input port. The first splitting means 51 splits a first optical signal input from the optical port P1. The first splitting means 51 is, for example, an optical coupler. The first splitting means 51 outputs one of the split first optical signals toward the second multiplexing means 56 and outputs the other of the split first optical signals toward the first wavelength filter 52.

The first wavelength filter 52 is an optical filter that transmits a second band, in a first optical signal, allocated to a first monitoring optical signal. The first wavelength filter 52 may block a first band. At that time, the first band is allocated to an optical signal including information toward the second terminal station 40. Thereby, the first monitoring optical signal allocated to the second band is output toward the first multiplexing means 55 from the first wavelength filter 52. The first wavelength filter 52 may not necessarily be provided.

A second optical signal output from the third switching means 32 is input to the optical port P4. The optical port P4 is relevant to a second input port. The second splitting means 53 splits the second optical signal input from the optical port P4. The second splitting means 53 is, for example, an optical coupler. The second splitting means 53 outputs one of the split second optical signals toward the first multiplexing means 55 and outputs the other of the split second optical signals toward the second wavelength filter 54.

The second wavelength filter 54 is an optical filter that transmits a fourth band, in a second optical signal, allocated to a second monitoring optical signal. The first wavelength filter 52 may block a third band. Herein, the third band is allocated to an optical signal including information toward the first terminal station 10. Thereby, the second monitoring optical signal allocated to the fourth band is output toward the second multiplexing means 56 from the second wavelength filter 54. The second wavelength filter 54 may not necessarily be provided.

A first monitoring optical signal from the first wavelength filter 52 and a second optical signal from the second splitting means 53 are input to the first multiplexing means 55. The first multiplexing means 55 multiplexes the input optical signals and outputs the multiplexed optical signal to the optical port P3. The optical port P3 is relevant to a second output port. Specifically, the first multiplexing means 55 outputs an optical signal including the second band, the third band, and the fourth band toward the optical port P3. Herein, the second band is allocated to the first monitoring optical signal. The third band is allocated to an optical signal including information toward the first terminal station 10. The fourth band is allocated to the second monitoring optical signal. Thereby, an optical signal from the first multiplexing means 55 is output to the first optical reception means 12 via the submarine optical cable 106, the fourth switching means 22, and the submarine optical cable 102.

A second monitoring optical signal from the second wavelength filter 54 and a first optical signal from the first splitting means 51 are input to the second multiplexing means 56. The second multiplexing means 56 multiplexes the input optical signals and outputs the multiplexed optical signal toward the optical port P2. The optical port P2 is relevant to a first output port. Specifically, the second multiplexing means 56 outputs an optical signal including the first band, the second band, and the fourth band toward the optical port P2. Herein, the first band is allocated to an optical signal including information toward the second terminal station 40. The second band is allocated to the first monitoring optical signal. The fourth band is allocated to the second monitoring optical signal. Thereby, an optical signal from the second multiplexing means 56 is output to the second optical reception means 42 via the submarine optical cable 105, the second switching means 31, and the submarine optical cable 107.

Next, details of the first switching means 21, the second switching means 31, the third switching means 32, and the fourth switching means 22 in the submarine optical communication system 1 are described. It is assumed that at least either of the first optical transmission means 11 and the second optical transmission means 41 can output, via a submarine optical cable, an instruction to the first switching means 21, the second switching means 31, the third switching means 32, and the fourth switching means 22. The first switching means 21, the second switching means 31, the third switching means 32, and the fourth switching means 22 switch, in accordance with the above-described instruction, a connection relation between submarine optical cables. For example, the first switching means 21 determines either of the submarine optical cable 103 and the submarine optical cable 105 to be connected to the submarine optical cable 101.

By using FIG. 3, a first state in the submarine optical communication system 1 is described. Solid lines in FIG. 3 indicate a submarine optical cable through which light can propagate. Dotted lines in FIG. 3 indicate a submarine optical cable through which light cannot propagate. In the first state, the first switching means 21 connects the submarine optical cable 101 and the submarine optical cable 103. The second switching means 31 connects the submarine optical cable 103 and the submarine optical cable 107. The third switching means 32 connects the submarine optical cable 104 and the submarine optical cable 108. The fourth switching means 22 connects the submarine optical cable 102 and the submarine optical cable 104.

By using FIG. 4, a second state in the submarine optical communication system 1 is described. Solid lines in FIG. 3 indicate a submarine optical cable through which light can propagate. Dotted lines in FIG. 4 indicate a submarine optical cable through which light cannot propagate. In the second state, the first switching means 21 connects the submarine optical cable 101 and the submarine optical cable 105. The second switching means 31 connects the submarine optical cable 105 and the submarine optical cable 107. The third switching means 32 connects the submarine optical cable 106 and the submarine optical cable 108. The fourth switching means 22 connects the submarine optical cable 102 and the submarine optical cable 106.

In the first state, the first optical reception means 12 receives a second optical signal output from the second optical transmission means 41. Herein, the second optical signal includes a third band and a fourth band. The third band is allocated to an optical signal including information toward the first terminal station 10. The fourth band is allocated to a second monitoring optical signal. In the second state, the first optical reception means 12 receives an optical signal including the second band, the third band, and the fourth band. Herein, the second band is allocated to a first monitoring optical signal. The third band is allocated to an optical signal including information toward the first terminal station 10. The fourth band is allocated to a second monitoring optical signal. The first optical reception means 12 detects, when the second band is not included in a received optical signal, that the submarine optical communication system 1 is in the first state. The first optical reception means 12 detects, when the second band is included in a received optical signal, that the submarine optical communication system 1 is in the second state.

In the first state, the second optical reception means 42 receives a first optical signal output from the first optical transmission means 11. Herein, the first optical signal includes a first band and a second band. The first band is allocated to an optical signal including information toward the second terminal station 40. The second band is allocated to a first monitoring optical signal. In the second state, the second optical reception means 42 receives an optical signal including a first band and a second band and an optical signal including a fourth band. The first band is allocated to an optical signal including information toward the second terminal station 40. The second band is allocated to a first monitoring optical signal. A fourth band is allocated to a second monitoring optical signal. The second optical reception means 42 detects, when the fourth bans is not included in a received optical signal, that the submarine optical communication system 1 is in the first state. The second optical reception means 42 detects, when the fourth band is included in a received optical signal, that the submarine optical communication system 1 is in the second state.

As described above, the submarine optical communication system 1 has been described. As described above, the submarine optical communication system 1 includes the loopback means 50 included in either of a first path (the submarine optical cable 103) and a second path (the submarine optical cable 105). The loopback means 50 outputs, to the first optical reception means 12, at least a part of a first optical signal output from the first optical transmission means.

In this manner, in the submarine optical communication system 1, when the first switching means 21 outputs a first optical signal to the first path, the first optical reception means 12 does not receive at least a part of the first optical signal. In contrast, when the first switching means 21 outputs a first optical signal to the second path, the first optical reception means 12 receives, from the loopback means 50, at least a part of the first optical signal.

Therefore, the first optical reception means 12 can determine, when not receiving at least a part of a first optical signal, that in the submarine optical communication system 1, the first path is being used. The first optical reception means 12 can determine, when receiving at least a part of the first optical signal, that in the submarine optical communication system 1, the second path is being used. In this manner, in the submarine optical communication system 1, it can be confirmed which cable is being used among a plurality of submarine optical cables. A communication means does not need to be provided for the first switching means 21, and therefore the submarine optical communication system 1 can improve reliability.

The first optical reception means 12 detects, when receiving at least a part of a first optical signal, that a first optical signal from the first switching means is being output to the second path. The first optical reception means 12 receives a first optical signal, for example, when the first wavelength filter 52 is not provided and the first switching means 21 is outputting a first optical signal to the second path (submarine optical cable 105).

In the above-described case, the first optical reception means 12 detects, when receiving a first optical signal, that a first optical signal from the first switching means 21 is being output to the second path.

It is assumed that the first optical transmission means 11 is outputting a first optical signal including a first band and a second band to the first splitting device 20. The first band is allocated to an optical signal including information toward the second terminal station 40. The second band is allocated to a first monitoring optical signal. The loopback means 50 further includes a wavelength filter (the first wavelength filter 52) transmitting, toward a second output port (the optical port P3), only an optical signal of a second band in a first optical signal split from a splitting means (the first splitting means 51). In this case, when the first switching means 21 is outputting a first optical signal to a second path (the submarine optical cable 105), the first optical reception means 12 receives an optical signal of a second band being at least a part of the first optical signal.

In the above-described case, the first optical reception means 12 detects, when receiving an optical signal of a second band, that a first optical signal from the first switching means is being output to the second path.

### Second Example Embodiment

A submarine optical communication system 2 according to a second example embodiment is described by using FIG. 5 and FIG. 6. FIG. 5 is a block diagram illustrating a configuration example of the submarine optical communication system 2. FIG. 6 is a block diagram illustrating details of the submarine optical communication system 2.

As illustrated in FIG. 5, the submarine optical communication system 2 includes a first terminal station 10, a first splitting device 20, a second splitting device 30, a second terminal station 40, and a loopback means 50. The first terminal station 10, the first splitting device 20, the second splitting device 30, the second terminal station 40, and the loopback means 50 according to the submarine optical communication system 2 may include a function and a connection relation similar to the first terminal station 10, the first splitting device 20, the second splitting device 30, the second terminal station 40, and the loopback means 50 according to the submarine optical communication system 2.

As illustrated in FIG. 5, components of each of the submarine optical communication system 1 are connected to submarine optical cables 101, 102, 103, 105, 106, and 107.

The first terminal station 10 includes a first optical transmission means 11 for outputting a first optical signal to the first splitting device 20 and a first optical reception means 12.

The first splitting device 20 includes a first switching means 21. The first switching means 21 outputs, via a first path (the submarine optical cable 103) or a second path (the submarine optical cable 104), a first optical signal from the first optical transmission means 11 toward the second splitting device 30.

The second splitting device 30 includes a second switching means 31. The second switching means 31 outputs, toward the second terminal station 40, the first optical signal output from the first switching means via the first path or the second path.

The second terminal station 40 includes a second optical reception means for receiving a first optical signal from the second switching means 31.

The second path (submarine optical cable 104) includes the loopback means 50. As illustrated in FIG. 6, the loopback means 50 includes a first input port P1, a splitting means 57, a first output port OP1, and a second output port OP2. The splitting means 57 is relevant to the first splitting means 51.

The first input port IP1 receives a first optical signal output from the first switching means 21. The first input port IP1 is relevant to the optical port P1. The splitting means 57 splits the first optical signal input from the first input port IP1. The first output port OP1 outputs, to the second switching means 31, one portion of the first optical signal split by the splitting means 57. The first output port OP1 is relevant to the optical port P2. The second output port OP2 outputs, to the first optical reception means 12, at least a part of the other portion of the first optical signal split by the splitting means 57. The second output port OP2 is relevant to the optical port P3.

As described above, the submarine optical communication system 2 has been described. As described above, the submarine optical communication system 2 includes the loopback means 50 provided for either of the first path (submarine optical cable 103) and the second path (submarine optical cable 105). The loopback means 50 outputs, to the first optical reception means 12, at least a part of a first optical signal output from the first optical transmission means.

In this manner, in the submarine optical communication system 2, when the first switching means 21 outputs a first optical signal to the first path, the first optical reception means 12 does not receive at least a part of the first optical signal. In contrast, when the first switching means 21 outputs a first optical signal to the second path, the first optical reception means 12 receives at least a part of the first optical signal from the loopback means 50.

Therefore, the first optical reception means 12 can determine, when not receiving at least a part of a first optical signal, that in the submarine optical communication system 2, the first path is being used. The first optical reception means 12 can determine, when receiving at least a part of a first optical signal, that in the submarine optical communication system 2, the second path is being used. In this manner, in the submarine optical communication system 2, it can be confirmed which path is being used among a plurality of paths. A communication means does not need to be provided for the first switching means 21, and therefore the submarine optical communication system 2 can improve reliability.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2 Submarine optical communication system
10 First terminal station
11 First optical transmission means
12 First optical reception means
20 First splitting device
21 First switching means
22 Fourth switching means
30 Second splitting device
31 Second switching means
32 Third switching means
40 Second terminal station
41 Second optical transmission means
42 Second optical reception means
50 Loopback means
51 First splitting means
52 First wavelength filter
53 Second splitting means
54 Second wavelength filter
55 First multiplexing means
56 Second multiplexing means
P1, P2, P3, P4 Optical port
IP1 First input port
OP1 First output port
OP2 Second output port
101, 102, 103, 104, 105, 106, 107, 108 Submarine optical cable

What is claimed is:

1. A submarine optical communication system comprising a first terminal station, a first splitting device, a second splitting device, and a second terminal station, wherein
the first terminal station includes a first optical transmitter configured to output a first optical signal to the first splitting device, and a first optical receiver;
the first splitting device includes a first switch configured to output a first optical signal from the first optical transmitter, toward the second splitting device via a first path or a second path;
the second splitting device includes a second switch configured to output, toward the second terminal station, the first optical signal being output from the first switch via the first path or the second path;
the second terminal station includes a second optical receiver configured to receive the first optical signal from the second switch;
the second path includes a loopback circuit; and
the loopback circuit includes
a first input port that receives the first optical signal being output from the first switch,
a splitter configured to split the first optical signal being input from the first input port,
a first output port that outputs, to the second switch, one of the first optical signal being split by the splitter, and
a second output port that outputs, to the first optical receiver, at least a part of another of the first optical signal being split by the splitter.

2. The submarine optical communication system according to claim 1, wherein the first optical receiver detects, when receiving at least a part of the first optical signal, that the first optical signal from the first switch is output to the second path.

3. The submarine optical communication system according to claim 1, wherein
the first optical transmitter outputs, to the first splitting device, the first optical signal including a first band allocated to an optical signal including information toward the second terminal station and a second band allocated to a first monitoring optical signal, and
the loopback circuit further includes a wavelength filter that transmits, toward the second output port, only an optical signal of the second band in the first optical signal being split from the splitter.

4. The submarine optical communication system according to claim 3, wherein the first optical receiver detects, when receiving the optical signal of the second band, that the first optical signal from the first switch is output to the second path.
